(19) United States
(12) Patent Application Publication
(10) Pub. No.: US 2026/0220684 A1
(43) Pub. Date: Jul. 30, 2026

(54) CROSS-CATEGORY RECOMMENDATION

(71) Applicant: Walmart Apollo, LLC, Bentonville, AR (US)

(72) Inventors: Shreyas Saiprasad Jadhav, San Francisco, CA (US); Shengwei Tang, San Jose, CA (US); Priyank Gupta, Duvall, WA (US); Pratik Saha, Dublin, CA (US); Yue Xu, San Francisco, CA (US); Hyun Duk Cho, San Francisco, CA (US); Praveen Kumar Kanumala, Newark, CA (US); Malay Kumar Patel, Fremont, CA (US); Sushant Kumar, San Jose, CA (US); Kannan Achan, Saratoga, CA (US)

(21) Appl. No.: 19/041,955

(22) Filed: Jan. 30, 2025

(51) Int. Cl. G06Q 30/0601

(52) U.S. Cl. CPC G06Q 30/0631

(57) ABSTRACT

Examples may be related to cross-category recommendation. An example may involve identifying an anchor item to be presented to a user via a user interface, wherein the anchor item is in a first category; and evaluating, using a machine learning model, a degree of cross-category intent of the user based at least partially on real-time interaction data of the user. The degree of cross-category intent may indicate a likelihood that the user will engage with any item in a second category that is different from the first category. An eligibility of the user to receive an item recommendation in the second category can be determined based on the degree of cross-category intent. A recommended item in the second category may be determined based on the eligibility, and presented to the user together with the anchor item in the user interface.

### BACKGROUND

Item recommendation tasks in retail industry improve user experiences by recommending items to users. A recommendation system can provide information about matches between users (e.g., customers) and items (e.g., books, electronics, grocery

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for providing a real-time cross-category recommendation, in accordance with some embodiments;

FIG. 2 is a block diagram of a cross-category recommendation computing device, in accordance with some embodiments;

FIG. 3 is a block diagram illustrating various portions of a system for providing a real-time cross-category recommendation, in accordance with some embodiments;

FIG. 4 illustrates an example architecture of a system for providing a real-time cross-category recommendation, in accordance with some embodiments;

FIG. 5 depicts an example system with a machine-readable medium that includes instructions for providing a real-time cross-category recommendation, in accordance with some embodiments;

FIG. 6 shows a flowchart illustrating an example method for providing a real-time cross-category recommendation, in accordance with some embodiments;

FIG. 7 shows a flowchart illustrating an example method for evaluating a degree of cross-category intent of a user, in accordance with some embodiments;

FIG. 8 shows a flowchart illustrating an example method for generating user-specific features based on real-time interaction data of a user within a current user session, in accordance with some embodiments;

FIG. 9 shows a flowchart illustrating an example method for generating a second cross-category score indicating a likelihood that a query will trigger a cross-category engagement in a current user session, in accordance with some embodiments;

FIG. 10 shows a flowchart illustrating an example method for presenting at least one recommended item based on a degree of cross-category intent of a user, in accordance with some embodiments;

FIG. 11 shows a flowchart illustrating an example method for providing an updated cross-category recommendation, in accordance with some embodiments.

### DETAILED DESCRIPTION

In some embodiments, systems and methods are described herein for providing real-time cross-category item recommendations. Items offered for sale by a retailer may fall into different categories, e.g., a general merchandise category, a grocery and food category, etc. While some users may shop items only in one category, some users shop items from two or more categories. When not receiving any recommendation, a customer who is doing routine grocery shopping would typically not think about shopping for general merchandise items. In some use cases, when a user is viewing or shopping items in one category, a disclosed system can recommend items in another category to the user

In some embodiments, before providing cross-category recommendations to users, the system determines who are the right users to target and when to target them for cross-category recommendations, to avoid introducing a friction in the users’ shopping journey. In some embodiments, to ensure that a user’s cross-category intent is seamless across all engagements, the system performs an analysis to compare effects of showing a cross-category recommendation module versus showing other types of modules to a user. In some embodiments, the system may show a cross-category recommendation together with other types of recommendations to a same user

In some embodiments, the system utilizes one or more machine learning models to generate a degree of cross-category intent of a user who has interacted with an anchor item in a first category. The degree of cross-category intent may indicate a likelihood that the user will engage with any item in a second category that is different from the first category. In some embodiments, the degree of cross-category intent may indicate whether, and to what degree, the user has a higher likelihood to engage with a cross-category recommendation compared to other recommendations. In some embodiments, the one or more machine learning models may be trained based on users’ past behaviors, e.g. typical inter-purchase intervals and shopping preferences, and based on in-session indications and contextual information related to the users, queries submitted by the users, etc. The one or more machine learning models can help the system to understand precisely a user’s cross-category intent in real-time, which enables the system to effectively target users for a cross-category shopping experience in a minimally intrusive manner

In some embodiments, the system can provide a nuanced and precise prediction of a user’s cross-category intent by computing a cross-category intent score that captures a real time dynamic nature of user interactions using in-session user features and contextual information on the user’s in-session journey. Utilizing the cross-category intent score, the system can facilitate and personalize cross-category experience of the user in a less intrusive manner, which is more consistent with the user’s in-session experience. The cross-category intent prediction can also be used for improving search and browsing experiences, helping users to explore cross-category browsing journey based on their preference and in-session interactions and an overall streamline of the user’s shopping journey

In various embodiments, a system including a processor and a non-transitory memory storing instructions is disclosed. The instructions, when executed, cause the processor to: identify an anchor item to be presented to a user via a user interface, wherein the anchor item is in a first category; evaluate, using at least one machine learning model, a degree of cross-category intent of the user based at least partially on real-time interaction data of the user, wherein the degree of cross-category intent indicates a likelihood that the user will engage with any item in a second category that is different from the first category; determine an eligibility of the user to receive an item recommendation in the second category based on the degree of cross-category intent; determine at least one recommended item in the second category based on the eligibility; and present, based on the degree of cross-category intent, the at least one recommended item to the user together with the anchor item in the user interface

In various embodiments, a computer-implemented method is disclosed. The computer-implemented method includes: identifying an anchor item to be presented to a user via a user interface, wherein the anchor item is in a first category; evaluating, using at least one machine learning model, a degree of cross-category intent of the user based at least partially on real-time interaction data of the user, wherein the degree of cross-category intent indicates a likelihood that the user will engage with any item in a second category that is different from the first category; determining an eligibility of the user to receive an item recommendation in the second category based on the degree of cross-category intent; determining at least one recommended item in the second category based on the eligibility; and presenting, based on the degree of cross-category intent, the at least one recommended item to the user together with the anchor item in the user interface

In various embodiments, a non-transitory computer readable medium having instructions stored thereon is disclosed. The instructions, when executed by at least one processor, cause at least one device to perform operations including: identifying an anchor item to be presented to a user via a user interface, wherein the anchor item is in a first category; evaluating, using at least one machine learning model, a degree of cross-category intent of the user based at least partially on real-time interaction data of the user, wherein the degree of cross-category intent indicates a likelihood that the user will engage with any item in a second category that is different from the first category; determining an eligibility of the user to receive an item recommendation in the second category based on the degree of cross-category intent; determining at least one recommended item in the second category based on the eligibility; and presenting, based on the degree of cross-category intent, the at least one recommended item to the user together with the anchor item in the user interface

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems

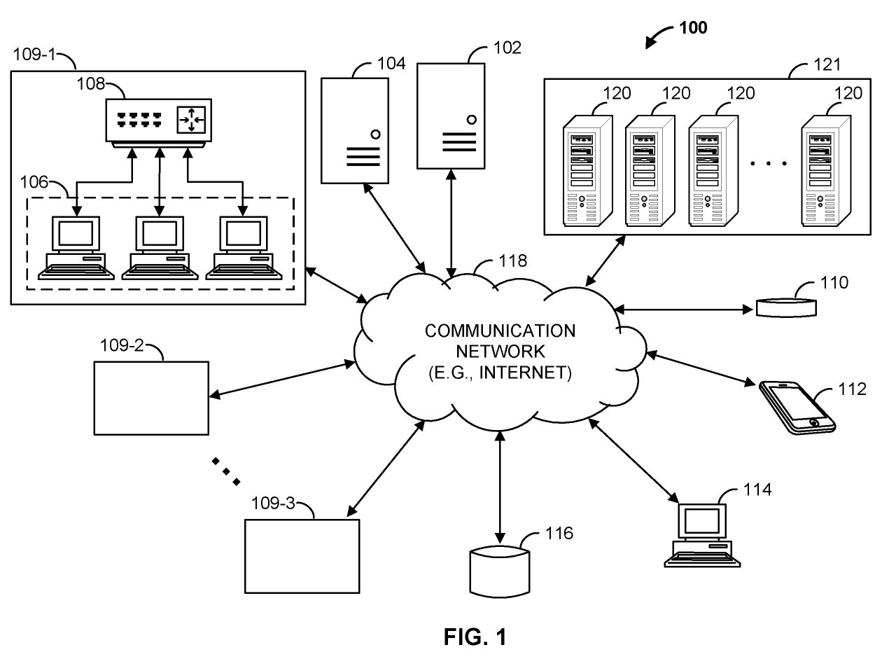

Turning to the drawings, FIG. 1 is a network environment 100 configured for providing a real-time cross-category recommendation, in accordance with some embodiments. The network environment 100 includes a plurality of devices or systems that can communicate over one or more network channels, illustrated as a network cloud 118. For example, in various embodiments, the network environment 100 can include, but not limited to, a cross-category recommendation computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The cross-category recommendation computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118

In some examples, each of the cross-category recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the cross-category recommendation computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or applications providing one or more products or services. In some examples, the cross-category recommendation computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider)

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the cross-category recommendation computing device 102 over the communication network 118. The workstation(s) 106 may send data to, and receive data from, the cross-category recommendation computing device 102. For example, the workstation(s) 106 may transmit data identifying transactions, inventory, assortment, supply chain data and/or waste data at the one or more fulfillment nodes 109 to the cross-category recommendation computing device 102. The workstation(s) 106 may also transmit other data related to the one or more fulfillment nodes 109 to the cross-category recommendation computing device 102.

Although FIG. 1 illustrates three user computing devices 110, 112, 114, the network environment 100 can include any number of user computing devices 110, 112, 114. Similarly, the network environment 100 can include any number of the cross-category recommendation computing devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer’s website, hosted by the server 104. The server 104 may capture user session data related to a customer’s activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the cross-category recommendation computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the cross-category recommendation computing device 102.

In some examples, the cross-category recommendation computing device 102 may receive a recommendation request from the server 104. The recommendation request may be sent standalone, together with, or embedded in user session data associated with user interactions of a user during a session, to seek recommendations to the user based on an anchor item in the user session data. The anchor item may be in a first category and will be presented to the user via a user interface. In some embodiments, the cross-category recommendation computing device 102 evaluates a degree of cross-category intent of the user based at least partially on the real-time user session data of the user. The degree of cross-category intent indicates a likelihood that the user will engage with any item in a second category that is different from the first category. The cross-category recommendation computing device 102 may determine an eligibility of the user to receive an item recommendation in the second category based on the degree of cross-category intent, and determine at least one recommended item in the second category based on the eligibility. The at least one recommended item may be identified in recommendation data sent back from the cross-category recommendation computing device 102 to the server 104, and will be presented to the user together with the anchor item in the user interface.

In some embodiments, the cross-category recommendation computing device 102 is further operable to communicate with the database 116 over the communication network 118. For example, the cross-category recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the cross-category recommendation computing device 102, in some examples, the database 116 can be a local storage device, such as a hard drive, a non-volatile memory, or a USB stick. For example, the cross-category recommendation computing device 102 may store online purchase data received from the server 104 in the database 116. The cross-category recommendation computing device 102 may receive in-store purchase data and node related data from different fulfillment nodes 109 and store them in the database 116. The cross-category recommendation computing device 102 may also receive from the server 104 user session data identifying events associated with browsing sessions, and may store the user session data in the database 116. The cross-category recommendation computing device 102 may also compute recommendation data in response to a recommendation request received from the server 104 (or the fulfillment nodes 109), and may store the recommendation data in the database 116.

In some examples, the cross-category recommendation computing device 102 generates and/or updates different models (e.g., machine learning models, deep learning models, statistical models, algorithms, etc.) for providing a real-time cross-category recommendation. The cross-category recommendation computing device 102 may generate training data for the models based on data including but not limited to: item metadata, user metadata, historical user behavior data, labelled user intent data, historical user query data, product type data, labelled query-based cross-category intent data, historical cross-category engagement data, and labelled cross-category intent data. The cross-category recommendation computing device 102 trains the models based on their corresponding training data, and stores the models in a database, such as in the database 116 (e.g., a cloud storage). The models, when executed by the cross-category recommendation computing device 102, allow the cross-category recommendation computing device 102 to generate cross-category recommendations.

In some examples, the cross-category recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the cross-category recommendation computing device 102 may generate real-time cross-category recommendations.

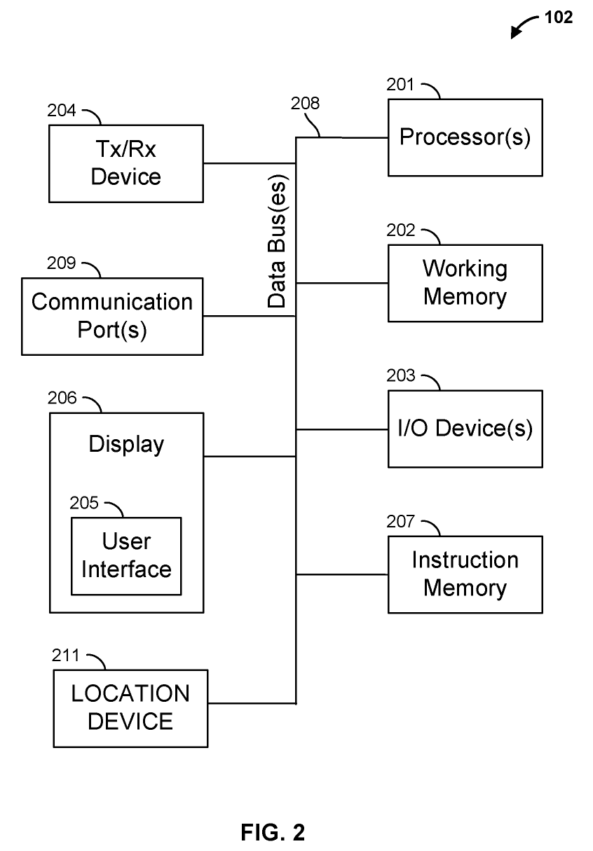

FIG. 2 illustrates a block diagram of a cross-category recommendation computing device, e.g. the cross-category recommendation computing device 102 of FIG. 1, in accordance with some embodiments. In some embodiments, each of the cross-category recommendation computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the cross-category recommendation computing device 102 can be combined, omitted, and/or replicated. In addition, it will be appreciated that additional elements other than those illustrated in FIG. 2 can be added to the cross-category recommendation computing device 102.

As shown in FIG. 2, the cross-category recommendation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the cross-category recommendation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the cross-category recommendation computing device 102 can include a single memory unit to operate as both instruction memory and working memory. Further, although embodiments are discussed herein including non-volatile memory, it will be appreciated that the cross-category recommendation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the cross-category recommendation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the cross-category recommendation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the cross-category recommendation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the cross-category recommendation computing device 102 and/or the server 104. For example, the user interface 205 can be a user interface for an application of a network environment operator that allows a customer to view and interact with the operator’s website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the cross-category recommendation computing device 102 may determine a local geographical area (e.g., town, city, state, etc.) of its position.

In some embodiments, the cross-category recommendation computing device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub- modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

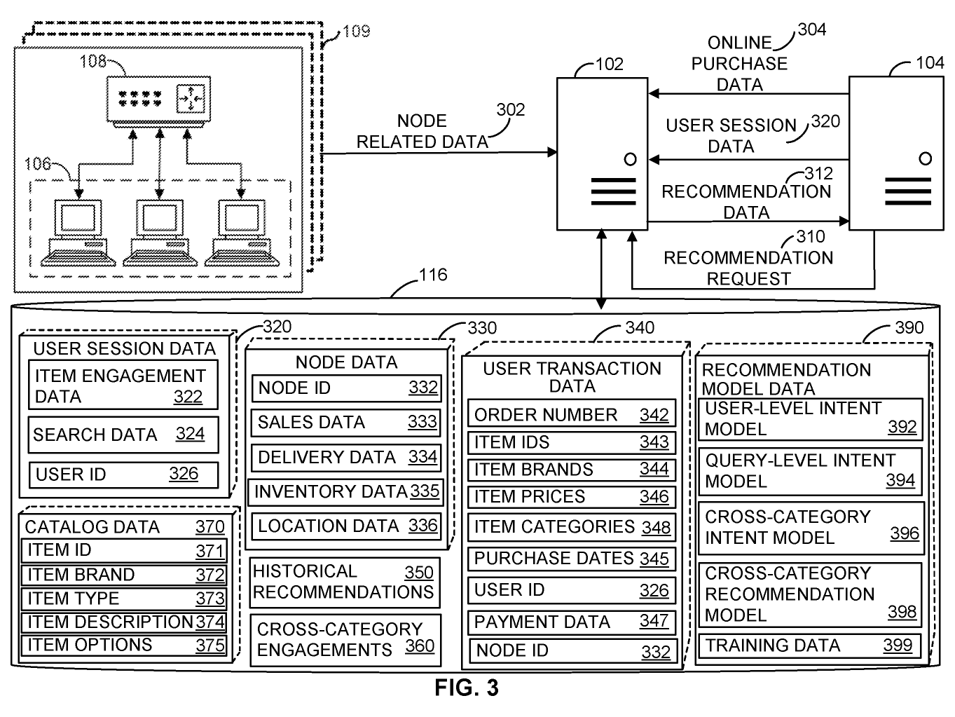

FIG. 3 is a block diagram illustrating various portions of a system for providing a real-time cross-category recommendation, e.g. the system shown in the network environment 100 of FIG. 1, in accordance with some embodiments. As indicated in FIG. 3, the cross-category recommendation computing device 102 may receive user session data 320 from the server 104, and store the user session data 320 in the database 116. The user session data 320 may identify, for each user (e.g., customer, seller, associate), data related to that user’s browsing session, such as when browsing a retailer’s webpage hosted by the server 104. In some embodiments, the system may not utilize all of the components and data shown in FIG. 3 for providing a real-time cross-category recommendation.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user’s online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The cross-category recommendation computing device 102 may also receive online purchase data 304 from the server 104, which identifies and characterizes one or more online purchases, such as purchases made by the user and other users via a retailer’s website hosted by the server 104. The cross-category recommendation computing device 102 may also receive node related data 302 from the fulfillment nodes 109, which identifies and characterizes one or more in-store purchases, product location data, inventory data, and assortment data related to each of the fulfillment nodes 109. In some embodiments, the node related data 302 may also indicate other information about the fulfillment nodes 109. In some embodiments, the fulfillment nodes 109 and the server 104 are associated with each other such that the online purchase data, the user session data 320 and the store related data 302 all come from a same server cluster or datacenter.

The cross-category recommendation computing device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc).

In some examples, the cross-category recommendation computing device 102 receives a recommendation request 310 from the server 104. For example, the recommendation request 310 may be generated based on a search query submitted by a user. The recommendation request 310 may be associated with an anchor item or query item to be displayed to a user via a user interface, e.g. after the user submits the search query including the anchor item, or after the user clicks on an advertisement or promotion related to the anchor item. In some examples, the anchor item is in a first category of a retailer’s product categories. In some embodiments, the recommendation request 310 may be sent to the cross-category recommendation computing device 102 as part of the user session data 320.

After receiving the recommendation request 310, the cross-category recommendation computing device 102 may evaluate, using at least one machine learning model, a degree of cross-category intent of the user based at least partially on real-time interaction data of the user. The degree of cross-category intent indicates a likelihood that the user will engage with any item in a second category that is different from the first category. The cross-category recommendation computing device 102 can determine an eligibility of the user to receive an item recommendation in the second category based on the degree of cross-category intent, and determine at least one recommended item in the second category based on the eligibility. In response to the recommendation request 310, the cross-category recommendation computing device 102 transmits the recommendation data 312 to the server 104. The recommendation data 312 may identify the at least one recommended item to be displayed to the user together with the anchor item in the user interface.

In some embodiments, the cross-category recommendation computing device 102 may generate node data 330 based on the node related data 302. In some examples, the node data 330 may include, for each node, one or more of: the node ID 332 of the node, sales data 333 indicating data of historical sales for each item in the node, delivery data 334 indicating data of historical deliveries of each item to and from the node, inventory data 335 identifying and charactering an inventory status for each item in the node, and location data 336 identifying a location of the node.

In some examples, the database 116 may also store historical recommendations 350 to users. The historical recommendations 350 may include both same-category recommendations and cross-category recommendations. In some examples, the database 116 may also store cross-category engagements 360 by users. The cross-category engagements 360 may identify engagement data of users who showed cross-category experience, e.g. engaging with items in multiple categories in a same user session.

The database 116 may also store recommendation model data 390 identifying and characterizing one or more models and related data for providing a real-time cross-category recommendation. For example, the recommendation model data 390 may include: a user-level intent model 392, a query-level intent model 394, a cross-category intent model 396, a cross-category recommendation model 398 and training data 399. In various embodiments, the recommendation model data 390 includes any number of the user-level intent models 392, the query-level intent models 394, the cross-category intent models 396, and the cross-category recommendation models 398.

The user-level intent model 392 in some examples can be used to generate a first cross-category score indicating a likelihood that a user has a real-time intent to perform cross-category engagement in a current user session. The first cross-category score may be generated based on user-specific features of the user. The user-specific features may be generated based on real-time interaction data of the user within the current user session and historical data of the user during a past time period. In some embodiments, the user-level intent model 392 is a machine learning model trained based on a first training data set including: item metadata, user metadata, historical user behavior data, and labelled user intent data.

The query-level intent model 394 in some examples can be used to generate a second cross-category score indicating a likelihood that a query will trigger a cross-category engagement in a current user session. The query is submitted by the user within the current user session. The second cross-category score may be generated based on query related features and the query submitted by the user. The query related features may be generated based on: the user-specific features of the user, a product type mapping from item data, a product type mapping from query data of a plurality of users, and historical cross-category data of a plurality of users. In some embodiments, the query-level intent model 394 is a machine learning model trained based on a second training data set including: at least part of the first training data set used to train the user-level intent model 392, historical user query data, product type data and labelled query-based cross-category intent data.

The cross-category intent model 396 in this example can be used to generate a degree of cross-category intent of the user based on the first cross-category score generated by the user-level intent model 392 and the second cross-category score generated by the query-level intent model 394. The degree of cross-category intent indicates a likelihood that the user will engage with a cross-category item recommendation. In some embodiments, the cross-category intent model 396 is a machine learning model trained based on a third training data set including: at least part of the first training data set used to train the user-level intent model 392, at least part of the second training data set used to train the query-level intent model 394, historical cross-category engagement data, labelled cross-category intent data.

The cross-category recommendation model 398 in this example can be used to determine an eligibility of a user to receive a cross-category item recommendation based on the degree of cross-category intent generated by the cross-category intent model 396, and determine at least one recommended item as cross-category recommendation based on the eligibility. The cross-category recommendation model 398 may also be used to determine how to present the cross-category recommendation to the user based on the degree of cross-category intent. In some examples, the at least one recommended item is presented to the user together with an anchor item in a user interface.

In some embodiments, there are multiple modules presented in the user interface, where each module corresponds to a different type of recommendations including the cross-category recommendation. For example, the user interface may show a same-category recommendation module listing items in a same category as the anchor item; and show a cross-category recommendation module listing items in a different category from the anchor item. The cross-category recommendation model 398 may be used to organize the modules including a cross-category recommendation module showing the at least one recommended item in the user interface. A location of the cross-category recommendation module in the user interface may be determined based on: the degree of cross-category intent of the user, a page type of a webpage shown in the user interface, and contextual content in the user interface. In some embodiments, after receiving updated real-time interaction data of the user, the system can determine an updated degree of cross-category intent of the user based at least partially on the updated real-time interaction data, and reorganize the cross-category recommendation module corresponding to the at least one recommended item to an updated location in the user interface based at least partially on the updated degree of cross-category intent of the user.

In some embodiments, one or more of the user-level intent models 392, the query-level intent models 394, the cross-category intent models 396, and the cross-category recommendation models 398 can be implemented as a machine learning model. The training data 399 may include data utilized for training one or more of the user-level intent models 392, the query-level intent models 394, the cross-category intent models 396, and the cross-category recommendation models 398. In some examples, the training data 399 may be formed based on: item metadata, user metadata, historical user behavior data, labelled user intent data, historical user query data, product type data, labelled query-based cross-category intent data, historical cross-category engagement data, and/or labelled cross-category intent data, obtained from either real data or synthetic data.

In some embodiments, the cross-category recommendation computing device 102 may assign one or more of the above described operations to a different processing unit or virtual machine hosted by one or more processing devices 120. Further, the cross-category recommendation computing device 102 may obtain the outputs of the these assigned operations from the processing units, and generate the recommendation data 312 based on the outputs.

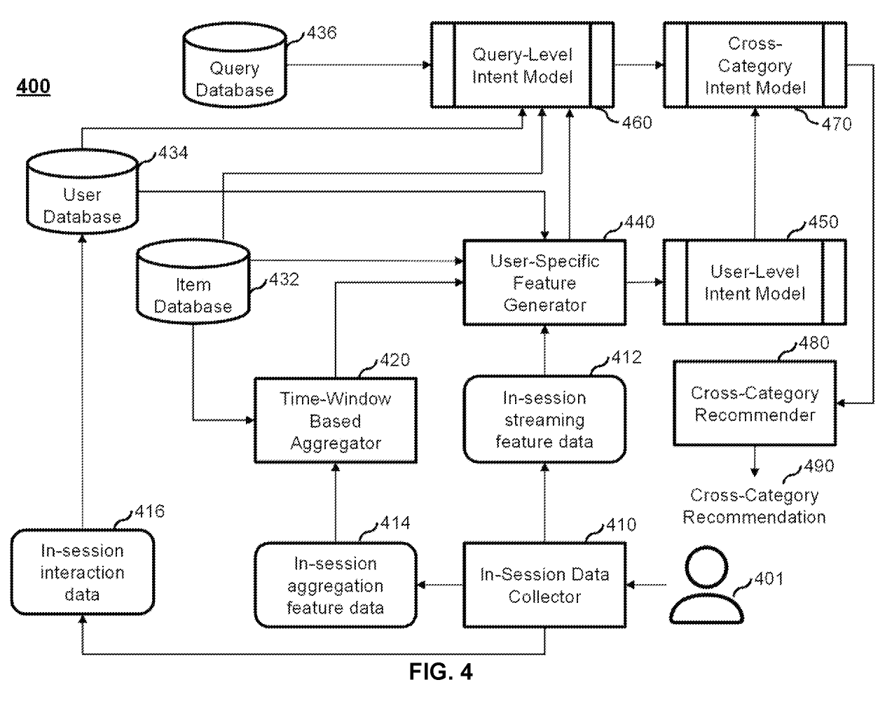

FIG. 4 illustrates an example architecture of a system 400 for providing a real-time cross-category recommendation, in accordance with some embodiments. In some embodiments, the system 400 can be implemented by one or more computing devices, such as the cross-category recommendation computing device 102, the server 104, and/or the cloud-based engine 121 of FIG. 1.

As shown in FIG. 4, the system 400 in this example includes an in-session data collector 410, a time-window based aggregator 420, a user-specific feature generator 440, a user-level intent model 450, a query-level intent model 460, a cross-category intent model 470 and a cross-category recommender 480. In some examples, the in-session data collector 410 can collect data of interactions of a user 401 with a website or application (e.g., a mobile application, software application, etc.) in real-time. For example, for each user session, the in-session data collector 410 may collect data recording the interactions of the user 401 within the session, and generate in-session streaming feature data 412, in-session aggregation feature data 414, and in-session interaction data 416.

In some examples, the in-session streaming feature data 412 may include latest interaction information of the user 401, e.g. recently viewed items, product types of latest items viewed, latest activities like act-to-cart and click, and latest queries submitted by the user 401, within a current or latest user session. The in-session streaming feature data 412 may be generated and streamed to the user-specific feature generator 440 in real-time.

In some examples, the in-session aggregation feature data 414 may include window-based stream data of the user interactions. For example, the in-session aggregation feature data 414 may include features of user interactions (e.g. browsing, clicks, add-to-cart) to be aggregated within a time window, e.g. a 15-minute user session. The in-session aggregation feature data 414 may be generated and streamed to the time-window based aggregator 420 in real-time. The time-window based aggregator 420 in some examples can aggregate the features obtained from the in-session aggregation feature data 414 for each time window, e.g. each user session, to generate aggregated features. In some embodiments, the aggregated features are generated based on item data obtained from an item database 432, which may be part of the database 116 or a standalone database. The item database 432 may include item metadata (e.g. item ID, item category, product type, popularity, price, product category, etc.) for items in all categories. The aggregated features may be sent to the user-specific feature generator 440 for user-specific feature generation.

In some examples, the in-session interaction data 416 may include cross-category interaction data of the user 401, identifying item interactions of the user 401 with cross-category recommendation modules. For example, the in-session interaction data 416 may identify: item ID, browsing, clicks, add-to-cart, etc. related to the user’s cross-category interactions. The in-session aggregation feature data 414 may be generated and stored in a user database 434, which may be part of the database 116 or a standalone database. The user database 434 may include historical data and features of different users, e.g. historical cross-category intent data, item interaction history, customer ID and item interaction data regarding cross-category modules, etc. of the users. In some embodiments, the user database 434 includes data reflecting users’ historical behavioral patterns.

The user-specific feature generator 440 in some examples can generate user-specific features based on the real-time interaction data of the user 401 within a current user session and historical data of the user 401 during a past time period. For example, the user-specific feature generator 440 may obtain: the in-session streaming feature data 412 identifying streaming features of the user 401 within the current user session based on the real-time interaction data, the aggregation data from the time-window based aggregator 420 identifying aggregation features of the user 401 over a time window within the current user session based on the real-time interaction data, the item data from the item database 432 identifying metadata of a plurality of items in different categories, and some user data from the user database 434 identifying historical cross-category intent and item interaction history of the user 401 during the past time period. The user-specific feature generator 440 may combine and process all of the obtained data to generate the user-specific features, e.g. by converting data from different sources in different formats to a unique format, removing noise and outlier from data, and combining the data together in a structured manner. The user-specific features are features specific to the user 401, regarding cross-category intent evaluation. The user-specific features may be applied to the user-level intent model 450 to estimate a degree of user-level cross-category intent of the user 401. The user-specific features may also be applied to the query-level intent model 460 to estimate a degree of query-level cross-category intent of the user 401.

The user-level intent model 450 in some examples can be used to generate, based on the user-specific features obtained from the user-specific feature generator 440, a first cross-category score indicating a likelihood that the user 401 has a real-time intent to perform cross-category engagement in the current user session or in the next instance. In some embodiments, the first cross-category score is generated based on a cross-category item recommendation that maximizes an engagement likelihood of the user 401 regarding cross-category item recommendations given the user-specific features. The user-level intent model 450 was trained to find the most attractive cross-category item recommendation that maximizes an engagement likelihood of the user 401 regarding cross-category item recommendations given the user-specific features, and the degree of user-level cross-category intent of the user 401 may be estimated given that the user 401 will receive the most attractive cross-category item recommendation. In some embodiments, the user-level intent model 450 is a first machine learning model trained based on a first training data set including: item metadata, user metadata, historical user behavior data, and labelled user intent data. In some embodiments, the user-level intent model 450 is feed forward neural network which can provide the user’s cross-category probability of transacting a cross-category item as soon as the user starts a session and interacts with items on a webpage. In some embodiments, the user-level intent model 450 may be implemented as the user-level intent model 392 in FIG. 3. In some embodiments, the output of the user-level intent model 450 may be sent as an input to the cross-category intent model 470.

The query-level intent model 460 in some examples can be used to generate, based on query related features and a query submitted by the user 401 within a current user session, a second cross-category score indicating a likelihood that the query will trigger a cross-category engagement in the current user session or at the next instance. The second cross-category score may be generated based on how many or how frequently cross-category interactions were performed in the past after this query or a similar query was submitted by users. In some embodiments, this likelihood indicated by the second cross-category score may be generated at a product type level, as a likelihood that a product type corresponding to the query (or all queries belonging to this product type) will trigger a cross-category engagement in the current user session or at the next instance.

In some embodiments, the query-level intent model 460 obtains (or generates) query related features based on inputs from the user-specific feature generator 440, the item database 432, the user database 434 and the query database 436 to generate the second cross-category score. For example, the query-level intent model 460 may receive user-specific features related to one or more queries submitted by the user 401 from the user-specific feature generator 440. The query-level intent model 460 may also receive from the item database 432: item data identifying item features, and mapping data identifying a mapping from each item to a corresponding product type (or a corresponding product category). The query-level intent model 460 may also receive from a query database 436 (which may be part of the database 116 or a standalone database): query data identifying queries submitted by users, and mapping data identifying a mapping from each query to a corresponding product type (or a corresponding product category). The query-level intent model 460 may also receive from the user database 434 historical cross-category data of a plurality of users, e.g. customer ID and item interaction data regarding cross-category modules for each user. In some embodiments, a data normalization is performed on the query submitted by the user 401 before to generate a normalized query to be input into the query-level intent model 460. For example, queries like “a computer,” “computer” and “computers” may all be normalized to be “computer.” In some embodiments, the query data obtained from the query database 436 at the query-level intent model 460 includes normalized queries generated based on historical interaction data of the plurality of users. The query-level intent model 460 may be used to generate the second cross-category score based on inputs including both the query related features and the normalized query.

In some embodiments, the second cross-category score is generated based on a cross-category product type recommendation that maximizes an engagement likelihood of the user 401 regarding cross-category product type recommendations given the query related features and the normalized query. The query-level intent model 460 was trained to find the most attractive cross-category product type recommendation that maximizes an engagement likelihood of the user 401 regarding cross-category product type recommendations given the query related features and the normalized query, and the degree of query-level cross-category intent of the user 401 may be estimated given that the user 401 will receive the most attractive cross-category product type recommendation. In some embodiments, the query-level intent model 460 is a second machine learning model trained based on a second training data set including: at least part of the first training data set, historical user query data, product type data and labelled query-based cross-category intent data. In some embodiments, the query-level intent model 460 may be implemented as the query-level intent model 394 in FIG. 3. In some embodiments, the output of the query-level intent model 460 may be sent as an input to the cross-category intent model 470.

The cross-category intent model 470 in some examples can be used to generate a degree of cross-category intent of the user 401 based on the first cross-category score output by the user-level intent model 450 and the second cross-category score output by the query-level intent model 460. The degree of cross-category intent may indicate a likelihood that the user 401 will engage with any item of a cross-category recommendation. For example, the user 401 may perform an interaction, like search, click, view, add-to-cart, etc., during a current user session to trigger an anchor item to be presented to the user 401 via a user interface. While the anchor item belongs to a first category, a cross-category recommendation includes recommending an item in a second category that is different from the first category. For example, while the first category is a grocery and food category, the second category is a general merchandise category. The degree of cross-category intent may indicate a likelihood that the user 401 will engage with such recommended item, when the recommended item is presented to the user 401 together with the anchor item in the user interface. In some embodiments, the cross-category intent model 470 may be used to generate the degree of cross-category intent of the user 401 by generating, based on the first cross-category score obtained from the user-level intent model 450 and the second cross-category score obtained from the query-level intent model 460, a final cross-category score indicating a likelihood that the user 401 will engage with any item in the second category that is different from the first category.

In some embodiments, the cross-category intent model 470 is a third machine learning model trained based on a third training data set including: at least part of the first training data set, at least part of the second training data set, historical cross-category engagement data, labelled cross-category intent data. In some embodiments, the cross-category intent model 470 is a logistic regression model which can combine scores from the user-level intent model 450 and the query-level intent model 460 to generate a contextual cross-category score as the final cross-category score. In some embodiments, the cross-category intent model 470 may be implemented as the cross-category intent model 396 in FIG. 3.

In some embodiments, the user-level intent model 450, the query-level intent model 460 and the cross-category intent model 470 are trained such that the final cross-category score indicates a first likelihood that the user 401 will engage with a cross-category recommendation, given a second likelihood that the user 401 will engage with a same-category recommendation (or without lowering the second likelihood). That is, the system 400 can provide cross-category recommendation to a user to increase the user’s cross-category engagement or interaction, without impacting the original same-category intent of the user.

In some embodiments, the user-level intent model 450, the query-level intent model 460 and the cross-category intent model 470 are trained based on historical data of a plurality of users regarding items in a plurality of categories including the first category and the second category (e.g. a general merchandise category, a grocery and food category, etc.). In some embodiments, the historical data are updated periodically, e.g. every day. For example, today’s historical data would include yesterday’s real-time data as feedback. In some embodiments, the training data includes null features and null values for users who have little or no historical interaction or experience to solve the cold start problem. In some embodiments, the user-level intent model 450, the query-level intent model 460 and the cross-category intent model 470 are re-trained periodically, e.g. every two weeks, or upon a request based on a new event.

The cross-category recommender 480 in some examples may determine an eligibility of the user 401 to receive a cross-category recommendation 490 based on the degree of cross-category intent or the final cross-category score generated by the cross-category intent model 470; and determine at least one recommended item as the cross-category recommendation 490 based on the eligibility. In some examples, the eligibility of the user 401 may be determined based on comparing the final cross-category score to a threshold. The cross-category recommendation 490 may be determined in accordance with a determination that the final cross-category score is greater than the threshold. Then, the cross-category recommender 480 can send the cross-category recommendation 490 to the user 401, by presenting the at least one recommended item of the cross-category recommendation 490 to the user 401 together with the anchor item in the user interface. In some examples, the threshold is predetermined by tuning a threshold to achieve a certain estimated percentage of queries that would trigger cross-category recommendation, or a certain estimated percentage of users that would trigger cross-category recommendation.

In some examples, the user interface is associated with a website or an application of a retailer. In some examples, the at least one recommended item may be presented in a cross-category recommendation module in a webpage shown in the user interface. In some examples, the webpage includes multiple modules corresponding to different items or item recommendations presented in the user interface. To present the cross-category recommendation module, the modules on the webpage may be organized or reorganized to assign the cross-category recommendation module to a location on the webpage. In some examples, the location of the cross-category recommendation module may be determined based on: the degree of cross-category intent of the user 401, a page type of the webpage, and contextual content in the user interface.

In some examples, after receiving updated real-time interaction data of the user 401, either in the current user session or in a new user session, the system 400 can determine an updated degree of cross-category intent of the user 401 based at least partially on the updated real-time interaction data. Then, the webpage presented to the user 401 may be updated by reorganizing the cross-category recommendation module to an updated location on the webpage in the user interface, based at least partially on the updated degree of cross-category intent of the user 401. For example, if the updated degree of cross-category intent is higher than the previous degree of cross-category intent or is higher than a predetermined threshold, the cross-category recommendation module may be moved upper towards the top of the webpage.

In some examples, the system 400 can determine an updated recommended item based on the updated degree of cross-category intent of the user 401, and present the updated recommended item to the user 401 together with the anchor item in the user interface. A location of a cross-category recommendation module corresponding to the updated recommended item in the user interface is determined based on: the updated degree of cross-category intent of the user, the page type of the webpage shown in the user interface, and contextual content in the user interface. In some embodiments, the updated real-time interaction data may be used to re-train the user-level intent model 450, the query-level intent model 460 and/or the cross-category intent model 470.

In some examples, the user interface may be an added-to-cart webpage presented to the user after the user adds the anchor item into a shopping cart. The added-to-cart webpage may include both a same-category recommendation module listing items in a same category as the anchor item, and a cross-category recommendation module listing items in a different category from the anchor item. The same-category recommendation module may be marked as “Items that pair well with what you added.” The cross-category recommendation module may be marked as “Don’t forget these great picks,” or “Shop these related top picks,” or “Popular items in your area.” Both modules are shown on the added-to-cart webpage when a final cross-category score generated for the user is higher than a first threshold. When the final cross-category score is higher than a second threshold that is larger than the first threshold, the cross-category recommendation module is shown on top of the same-category recommendation module on the added-to-cart webpage. When the final cross-category score is between the first threshold and the second threshold, the same-category recommendation module is shown on top of the cross-category recommendation module on the added-to-cart webpage. In some situations, after an updated final cross-category score for the user is generated, e.g. due to updated user interaction or context information, the location of the cross-category recommendation module may be moved up or down on the added-to-cart webpage when the user refreshes the added-to-cart webpage.

The above examples can also be applied to other types of webpages, e.g. search result page, shopping cart page, item description page, post add-to-cart page, thank you page (after an order is placed), etc. In some examples, different locations on a webpage may be ranked from most attractive positions to least attractive positions. The cross-category recommendation module may be shown at a default position on the webpage once the final cross-category score passes a basic threshold. As the final cross-category score becomes higher, the cross-category recommendation module may be moved to a higher attractive position on the webpage. As the final cross-category score becomes lower but still higher than the basic threshold, the cross-category recommendation module may be moved to a less attractive position on the webpage.

In some examples, a cross-category recommended item is inserted in a list of search results on a search result webpage. The search results are relevant items (as same-category recommendations) matching a query item or anchor item submitted by the user. The larger the final cross-category score for the user is, the higher rank the cross-category recommended item has in the list of search results.

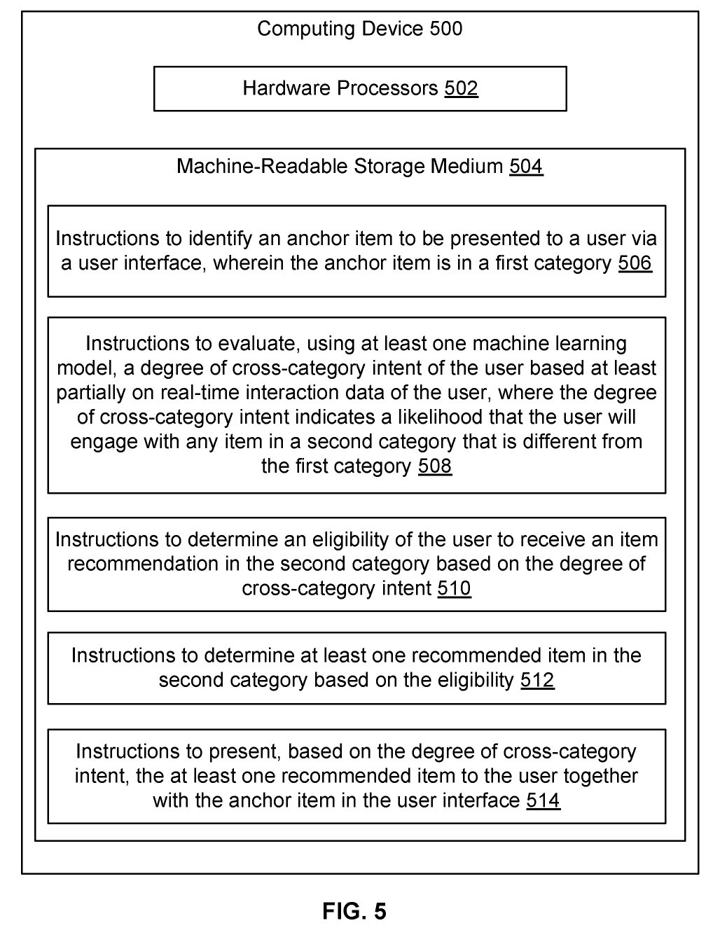

FIG. 5 depicts an example system 500 (e.g. a computing device) for providing a real-time cross-category recommendation, including a machine-readable medium 504 encoded with example instructions executable by processing resource 502, e.g. hardware processors, in accordance with some embodiments. In some implementations, the system 500 may be useful for implementing aspects of the system 400 of FIG. 4. In some implementations, functionality described with respect to FIG. 4 may be included in the instructions encoded on machine-readable medium 504.

The processing resource 502 may include a microcontroller, a microprocessor, central processing unit core(s), an ASIC, an FPGA, and/or other hardware device suitable for retrieval and/or execution of instructions from the machine-readable medium 504 to perform functions related to various examples. Additionally or alternatively, the processing resource 502 may include or be coupled to electronic circuitry or dedicated logic for performing some or all of the functionality of the instructions described herein.

The machine-readable medium 504 may be any medium suitable for storing executable instructions, such as RAM, ROM, EEPROM, flash memory, a hard disk drive, an optical disc, or the like. In some example implementations, the machine-readable medium 504 may be a tangible, non-transitory medium. The machine-readable medium 504 may be disposed within the system 500 in which case the executable instructions may be deemed installed or embedded on the system. Alternatively, the machine-readable medium 504 may be a portable (e.g., external) storage medium, and may be part of an installation package.

As described further herein below, the machine-readable medium 504 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 5.

The machine-readable medium 504 includes instructions 506–514. Instructions 506, when executed, cause the processing resource 502 to identify an anchor item to be presented to a user via a user interface. The anchor item is in a first category. The instructions 508, when executed, cause the processing resource 502 to evaluate, using at least one machine learning model, a degree of cross-category intent of the user based at least partially on real-time interaction data of the user. The degree of cross-category intent indicates a likelihood that the user will engage with any item in a second category that is different from the first category.

Instructions 510, when executed, cause the processing resource 502 to determine an eligibility of the user to receive an item recommendation in the second category based on the degree of cross-category intent. The instructions 512, when executed, cause the processing resource 502 to determine at least one recommended item in the second category based on the eligibility. The instructions 514, when executed, cause the processing resource 502 to present, based on the degree of cross-category intent, the at least one recommended item to the user together with the anchor item in the user interface.

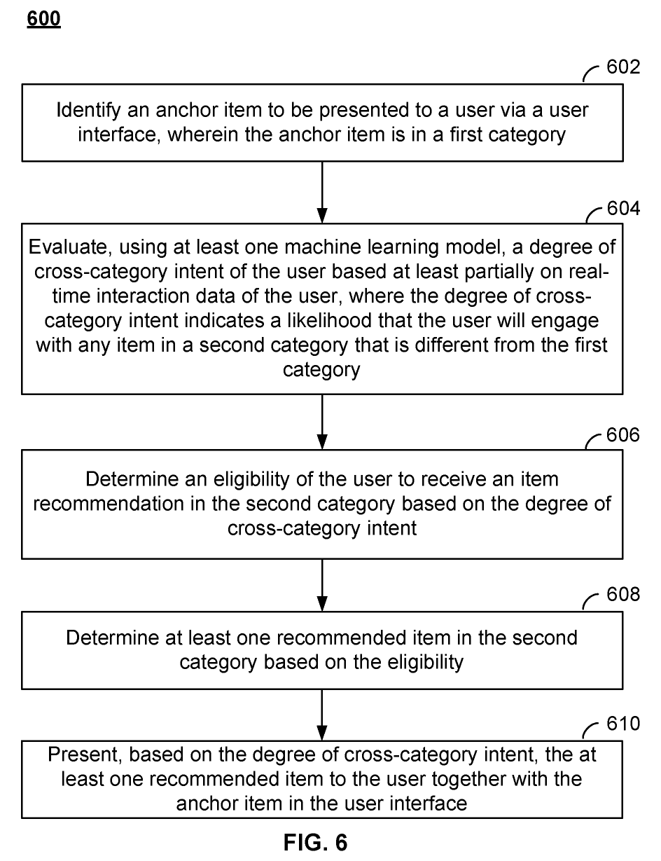

FIG. 6 illustrates an example method 600 for providing a real-time cross-category recommendation, in accordance with some embodiments. In some embodiments, the method 600 can be carried out by one or more computing devices, such as the cross-category recommendation computing device 102, the server 104, and/or the cloud-based engine 121 of FIG. 1.

As shown in FIG. 6, the method 600 starts from operation 602, where an anchor item is identified to be presented to a user via a user interface. The anchor item is in a first category. Then at operation 604, using at least one machine learning model, a degree of cross-category intent of the user is evaluated based at least partially on real-time interaction data of the user. The degree of cross-category intent indicates a likelihood that the user will engage with any item in a second category that is different from the first category. At operation 606, an eligibility of the user to receive an item recommendation in the second category is determined based on the degree of cross-category intent. At operation 608, at least one recommended item is determined in the second category based on the eligibility. At operation 610, based on the degree of cross-category intent, the at least one recommended item is presented to the user together with the anchor item in the user interface.

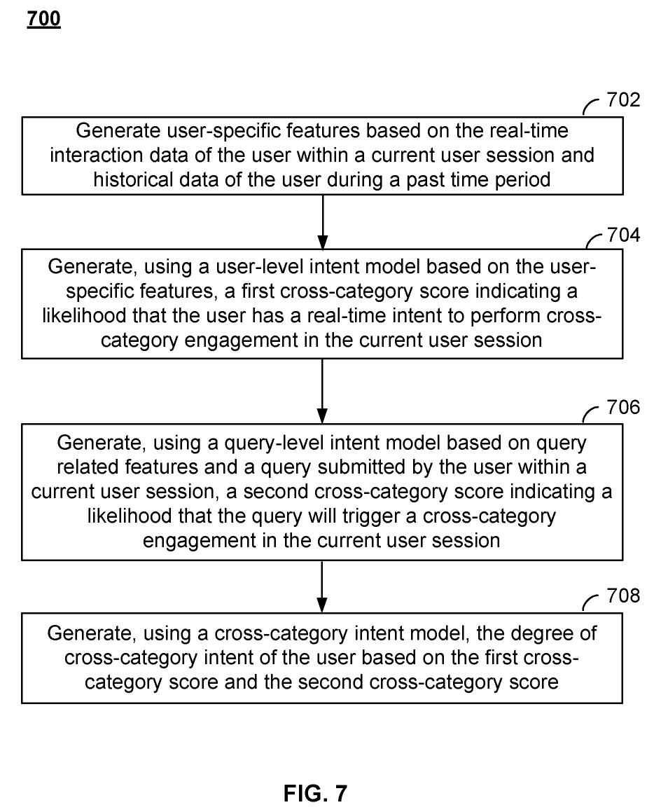

FIG. 7 illustrates an example method 700 for evaluating a degree of cross-category intent of a user, in accordance with some embodiments. In some embodiments, the method 700 can be performed as part of the operation 604 of the example method 600 in FIG. 6. In some embodiments, the process 700 can be carried out by a system including one or more computing devices, such as the cross-category recommendation computing device 102, the server 104, and/or the cloud-based engine 121 of FIG. 1.

As shown in FIG. 7, the method 700 starts from operation 702, where user-specific features are generated based on the real-time interaction data of the user within a current user session and historical data of the user during a past time period. Then at operation 704, using a user-level intent model based on the user-specific features, a first cross-category score is generated to indicate a likelihood that the user has a real-time intent to perform cross-category engagement in the current user session. At operation 706, using a query-level intent model based on query related features and a query submitted by the user within a current user session, a second cross-category score is generated to indicate a likelihood that the query will trigger a cross-category engagement in the current user session. At operation 708, using a cross-category intent model, the degree of cross-category intent of the user is generated based on the first cross-category score and the second cross-category score.

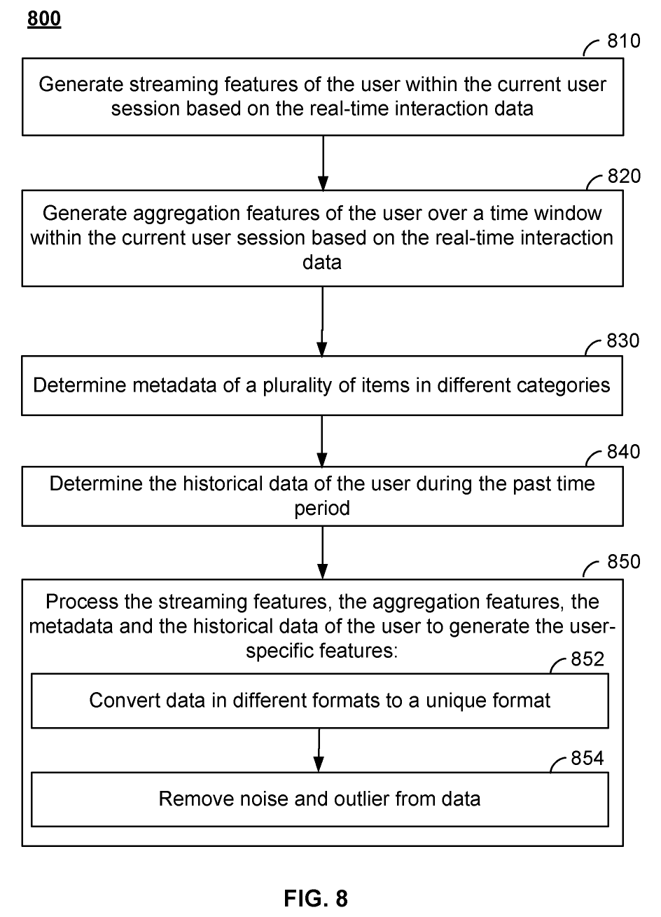

FIG. 8 illustrates an example method 800 for generating user-specific features based on real-time interaction data of a user within a current user session, in accordance with some embodiments. In some embodiments, the method 800 can be performed as part of the operation 702 of the example method 700 in FIG. 7. In some embodiments, the process 800 can be carried out by a system including one or more computing devices, such as the cross-category recommendation computing device 102, the server 104, and/or the cloud-based engine 121 of FIG. 1.

As shown in FIG. 8, the method 800 starts from operation 810, where streaming features of the user within the current user session are generated based on the real-time interaction data. Then at operation 820, aggregation features of the user over a time window within the current user session are generated based on the real-time interaction data. At operation 830, metadata of a plurality of items are determined in different categories. At operation 840, the historical data of the user are determined during the past time period. At operation 850, the streaming features, the aggregation features, the metadata and the historical data of the user are processed to generate the user-specific features. The operation 850 may include sub-operations 852 and 854. At sub-operation 852, data in different formats are converted to a unique format. At sub-operation 854, noise and outlier are removed from data.

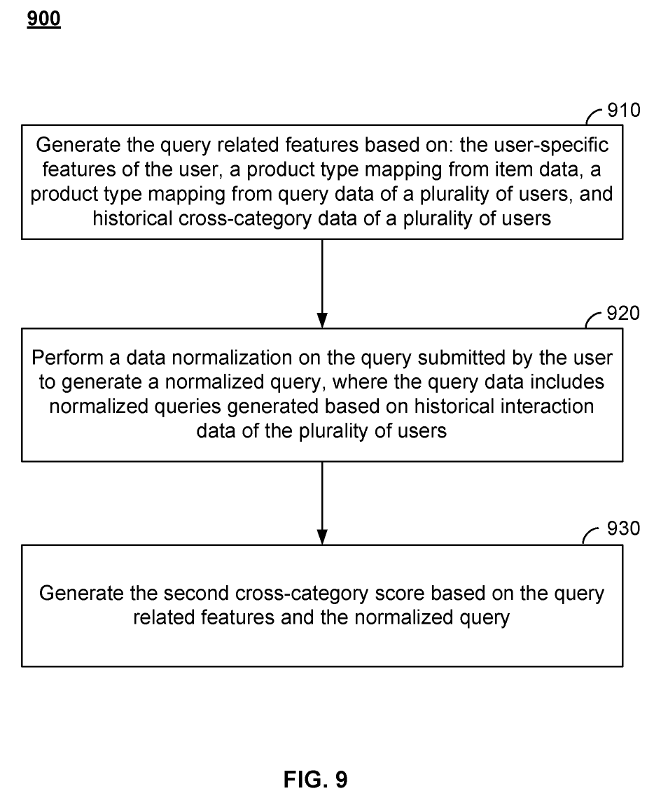

FIG. 9 illustrates an example method 900 for generating a second cross-category score indicating a likelihood that a query will trigger a cross-category engagement in a current user session, in accordance with some embodiments. In some embodiments, the method 900 can be performed as part of the operation 706 of the example method 700 in FIG. 7. In some embodiments, the process 900 can be carried out by a system including one or more computing devices, such as the cross-category recommendation computing device 102, the server 104, and/or the cloud-based engine 121 of FIG. 1.

As shown in FIG. 9, the method 900 starts from operation 910, where the query related features are generated based on: the user-specific features of the user, a product type mapping from item data, a product type mapping from query data of a plurality of users, and historical cross-category data of a plurality of users. Then at operation 920, a data normalization is performed on the query submitted by the user to generate a normalized query. The query data includes normalized queries generated based on historical interaction data of the plurality of users. At operation 930, the second cross-category score is generated based on the query related features and the normalized query.

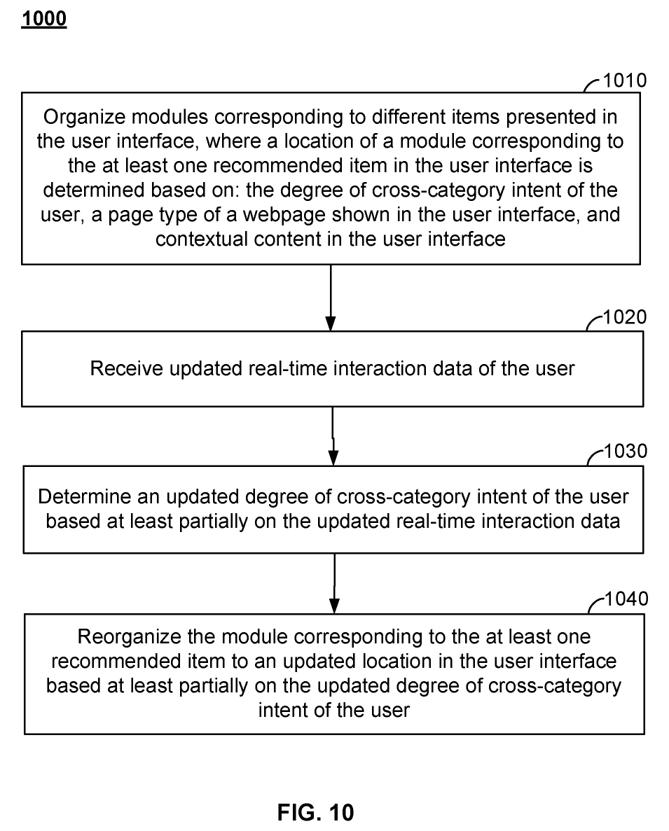

FIG. 10 illustrates an example method 1000 for presenting at least one recommended item based on a degree of cross-category intent of a user, in accordance with some embodiments. In some embodiments, the method 1000 can be performed as part of the operation 610 of the example method 600 in FIG. 6. In some embodiments, the process 1000 can be carried out by a system including one or more computing devices, such as the cross-category recommendation computing device 102, the server 104, and/or the cloud-based engine 121 of FIG. 1.

As shown in FIG. 10, the method 1000 starts from operation 1010, where modules corresponding to different items presented in the user interface are organized. A location of a module corresponding to the at least one recommended item in the user interface is determined based on: the degree of cross-category intent of the user, a page type of a webpage shown in the user interface, and contextual content in the user interface. Then at operation 1020, updated real-time interaction data of the user is received. At operation 1030, an updated degree of cross-category intent of the user is determined based at least partially on the updated real-time interaction data. At operation 1040, the module corresponding to the at least one recommended item is reorganized to an updated location in the user interface based at least partially on the updated degree of cross-category intent of the user.

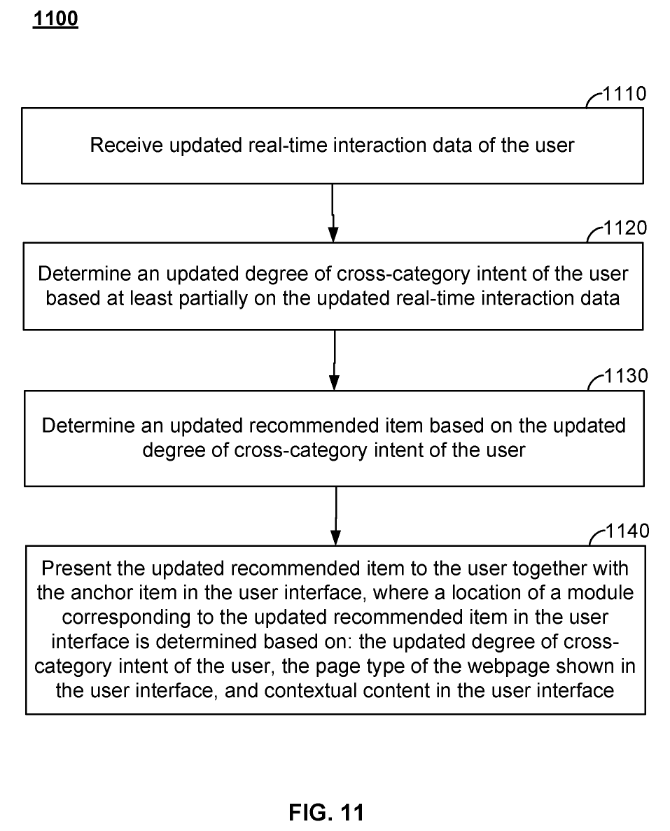

FIG. 11 shows a flowchart illustrating an example method 1100 for providing an updated cross-category recommendation, in accordance with some embodiments. In some embodiments, the method 1100 can be carried out by a system including one or more computing devices, such as the cross-category recommendation computing device 102 and/or the cloud-based engine 121 of FIG. 1. Beginning at operation 1110, updated real-time interaction data of the user is received. At operation 1120, an updated degree of cross-category intent of the user is determined based at least partially on the updated real-time interaction data. At operation 1130, an updated recommended item is determined based on the updated degree of cross-category intent of the user. At operation 1140, the updated recommended item is presented to the user together with the anchor item in the user interface. A location of a module corresponding to the updated recommended item in the user interface is determined based on: the updated degree of cross-category intent of the user, the page type of the webpage shown in the user interface, and contextual content in the user interface.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
identify an anchor item to be presented to a user via a user interface, wherein the anchor item is in a first category,
evaluate, using at least one machine learning model, a degree of cross-category intent of the user based at least partially on real-time interaction data of the user, wherein the degree of cross-category intent indicates a likelihood that the user will engage with any item in a second category that is different from the first category,
determine an eligibility of the user to receive an item recommendation in the second category based on the degree of cross-category intent,
determine at least one recommended item in the second category based on the eligibility, and
present, based on the degree of cross-category intent, the at least one recommended item to the user together with the anchor item in the user interface.

2. The system of claim 1, wherein the degree of cross-category intent of the user is evaluated based on:
generating user-specific features based on the real-time interaction data of the user within a current user session and historical data of the user during a past time period;
generating, using a user-level intent model based on the user-specific features, a first cross-category score indicating a likelihood that the user has a real-time intent to perform cross-category engagement in the current user session;
generating, using a query-level intent model based on query related features and a query submitted by the user within a current user session, a second cross-category score indicating a likelihood that the query will trigger a cross-category engagement in the current user session; and
generating, using a cross-category intent model, the degree of cross-category intent of the user based on the first cross-category score and the second cross-category score.

3. The system of claim 2, wherein generating the user-specific features comprises:
generating streaming features of the user within the current user session based on the real-time interaction data;
generating aggregation features of the user over a time window within the current user session based on the real-time interaction data;
determining metadata of a plurality of items in different categories;
determining the historical data of the user during the past time period; and
processing the streaming features, the aggregation features, the metadata and the historical data of the user to generate the user-specific features, wherein the processing comprises converting data in different formats to a unique format, and removing noise and outlier from data.

4. The system of claim 2, wherein:
the first cross-category score is generated based on a cross-category item recommendation that maximizes an engagement likelihood of the user regarding the cross-category item recommendation given the user-specific features.

5. The system of claim 2, wherein generating the second cross-category score comprises:
generating the query related features based on: the user-specific features of the user, a product type mapping from item data, a product type mapping from query data of a plurality of users, and historical cross-category data of a plurality of users;
performing a data normalization on the query submitted by the user to generate a normalized query, wherein the query data includes normalized queries generated based on historical interaction data of the plurality of users; and
generating the second cross-category score based on the query related features and the normalized query.

6. The system of claim 5, wherein:
the second cross-category score is generated based on a cross-category product type recommendation that maximizes an engagement likelihood of the user regarding the cross-category product type recommendation given the query related features and the normalized query.

7. The system of claim 2, wherein:
the user-level intent model is a first machine learning model trained based on a first training data set including: item metadata, user metadata, historical user behavior data, and labelled user intent data;
the query-level intent model is a second machine learning model trained based on a second training data set including: at least part of the first training data set, historical user query data, product type data and labelled query-based cross-category intent data; and
the cross-category intent model is a third machine learning model trained based on a third training data set including: at least part of the first training data set, at least part of the second training data set, historical cross-category engagement data, labelled cross-category intent data.

8. The system of claim 2, wherein:
generating the degree of cross-category intent of the user comprises generating, using the cross-category intent model based on the first cross-category score and the second cross-category score, a final cross-category score indicating the likelihood that the user will engage with any item in the second category that is different from the first category;
the eligibility of the user is determined based on comparing the final cross-category score to a threshold; and
the at least one recommended item is determined in the second category in accordance with a determination that the final cross-category score is greater than the threshold.

9. The system of claim 1, wherein:
the at least one machine learning model is trained based on historical data of a plurality of users regarding items in a plurality of categories including the first category and the second category;
the plurality of categories include: a general merchandise category and a grocery and food category; and
the user interface is associated with a website or an application of a retailer.

10. The system of claim 1, wherein the at least one recommended item is presented based on:
organizing modules corresponding to different items presented in the user interface, wherein a location of a module corresponding to the at least one recommended item in the user interface is determined based on: the degree of cross-category intent of the user, a page type of a webpage shown in the user interface, and contextual content in the user interface;
receiving updated real-time interaction data of the user;
determining an updated degree of cross-category intent of the user based at least partially on the updated real-time interaction data; and
reorganizing the module corresponding to the at least one recommended item to an updated location in the user interface based at least partially on the updated degree of cross-category intent of the user.

11. The system of claim 10, wherein the instructions, when executed, further cause the processor to:
determine an updated recommended item based on the updated degree of cross-category intent of the user; and
present the updated recommended item to the user together with the anchor item in the user interface, wherein a location of a module corresponding to the updated recommended item in the user interface is determined based on: the updated degree of cross-category intent of the user, the page type of the webpage shown in the user interface, and contextual content in the user interface,
wherein the updated real-time interaction data is used to re-train the at least one machine learning model.

12. A computer-implemented method, comprising:
identifying an anchor item to be presented to a user via a user interface, wherein the anchor item is in a first category;
evaluating, using at least one machine learning model, a degree of cross-category intent of the user based at least partially on real-time interaction data of the user, wherein the degree of cross-category intent indicates a likelihood that the user will engage with any item in a second category that is different from the first category;
determining an eligibility of the user to receive an item recommendation in the second category based on the degree of cross-category intent;
determining at least one recommended item in the second category based on the eligibility; and
presenting, based on the degree of cross-category intent, the at least one recommended item to the user together with the anchor item in the user interface.

13. The computer-implemented method of claim 12, wherein evaluating the degree of cross-category intent of the user comprises:
generating user-specific features based on the real-time interaction data of the user within a current user session and historical data of the user during a past time period;
generating, using a user-level intent model based on the user-specific features, a first cross-category score indicating a likelihood that the user has a real-time intent to perform cross-category engagement in the current user session;
generating, using a query-level intent model based on query related features and a query submitted by the user within a current user session, a second cross-category score indicating a likelihood that the query will trigger a cross-category engagement in the current user session; and
generating, using a cross-category intent model, the degree of cross-category intent of the user based on the first cross-category score and the second cross-category score.

14. The computer-implemented method of claim 13, wherein generating the user-specific features comprises:
generating streaming features of the user within the current user session based on the real-time interaction data;
generating aggregation features of the user over a time window within the current user session based on the real-time interaction data;
determining metadata of a plurality of items in different categories;
determining the historical data of the user during the past time period; and
processing the streaming features, the aggregation features, the metadata and the historical data of the user to generate the user-specific features, wherein the processing comprises converting data in different formats to a unique format, and removing noise and outlier from data.

15. The computer-implemented method of claim 13, wherein generating the second cross-category score comprises:
generating the query related features based on: the user-specific features of the user, a product type mapping from item data, a product type mapping from query data of a plurality of users, and historical cross-category data of a plurality of users;
performing a data normalization on the query submitted by the user to generate a normalized query, wherein the query data includes normalized queries generated based on historical interaction data of the plurality of users; and
generating the second cross-category score based on the query related features and the normalized query.

16. The computer-implemented method of claim 13, wherein:
generating the degree of cross-category intent of the user comprises generating, using the cross-category intent model based on the first cross-category score and the second cross-category score, a final cross-category score indicating the likelihood that the user will engage with any item in the second category that is different from the first category;
the eligibility of the user is determined based on comparing the final cross-category score to a threshold; and
the at least one recommended item is determined in the second category in accordance with a determination that the final cross-category score is greater than the threshold.

17. The computer-implemented method of claim 12, wherein presenting the at least one recommended item comprises:
organizing modules corresponding to different items presented in the user interface, wherein a location of a module corresponding to the at least one recommended item in the user interface is determined based on: the degree of cross-category intent of the user, a page type of a webpage shown in the user interface, and contextual content in the user interface;
receiving updated real-time interaction data of the user;
determining an updated degree of cross-category intent of the user based at least partially on the updated real-time interaction data; and
reorganizing the module corresponding to the at least one recommended item to an updated location in the user interface based at least partially on the updated degree of cross-category intent of the user.

18. The computer-implemented method of claim 17, further comprising:
determining an updated recommended item based on the updated degree of cross-category intent of the user; and
presenting the updated recommended item to the user together with the anchor item in the user interface, wherein a location of a module corresponding to the updated recommended item in the user interface is determined based on: the updated degree of cross-category intent of the user, the page type of the webpage shown in the user interface, and contextual content in the user interface,
wherein the updated real-time interaction data is used to re-train the at least one machine learning model.

19. A non-transitory computer readable medium having instructions stored thereon, wherein the instructions, when executed by at least one processor, cause at least one device to perform operations comprising:
identifying an anchor item to be presented to a user via a user interface, wherein the anchor item is in a first category;
evaluating, using at least one machine learning model, a degree of cross-category intent of the user based at least partially on real-time interaction data of the user, wherein the degree of cross-category intent indicates a likelihood that the user will engage with any item in a second category that is different from the first category;
determining an eligibility of the user to receive an item recommendation in the second category based on the degree of cross-category intent;
determining at least one recommended item in the second category based on the eligibility; and
presenting, based on the degree of cross-category intent, the at least one recommended item to the user together with the anchor item in the user interface.

20. The non-transitory computer readable medium of claim 19, wherein the operations further comprise:
generating user-specific features based on the real-time interaction data of the user within a current user session and historical data of the user during a past time period;
generating, using a user-level intent model based on the user-specific features, a first cross-category score indicating a likelihood that the user has a real-time intent to perform cross-category engagement in the current user session;
generating, using a query-level intent model based on query related features and a query submitted by the user within a current user session, a second cross-category score indicating a likelihood that the query will trigger a cross-category engagement in the current user session; and
generating, using a cross-category intent model, the degree of cross-category intent of the user based on the first cross-category score and the second cross-category score.
